(19) United States
(12) Patent Application Publication
(10) Pub. No.: US 2003/0161004 A1
(43) Pub. Date: Aug. 28, 2003

(54) Merging control panel images

(76) Inventor: Fernando Bolanos, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/087,174

(22) Filed: Feb. 28, 2002

(51) Int. Cl. G06F 15/00; G06K 1/00

(52) U.S. Cl. 358/1.18

(57) ABSTRACT

A system and methods combine images from various devices in a printing system and display an overall system image on the control panel of a printing device. Events in a printing system are associated with particular event codes. For example, an error event such as a paper jam in a printing device or other device coupled to the printing device is associated with a particular error code. When an event occurs, a printing device receives an associated event code. Based on the event code, the printing device merges images from one or more external devices with an image of itself. The merged image makes up an overall printing system image that is displayed on a control panel of the printing device. The system image provides information to a user about the nature and location of the event.

### TECHNICAL FIELD

The present disclosure relates to displaying images on a device control panel, and more particularly, to merging various device images into a system image for display on a control panel.

### BACKGROUND

Printing devices, such as laser printers, are often combinable with other external devices in order to facilitate the overall task of document preparation. For example, an external storage device can be attached to a high-speed laser printer as a paper input device to reduce the frequency with which the printer needs to be reloaded with paper. A high speed laser printer that prints 50 pages per minute might otherwise quickly run out of paper even though it has two embedded, 500 page input trays. An external output device might also be attached to the printer as a document finishing device. Such output devices can function as paper sorters, paper stackers and paper binders. A stapler/stacker output device might offer various ways of stapling documents together such as placing staples down the side of a document, or placing a staple in the corner of a document at different angles. FIG. 1 illustrates an example of a printing system that includes a printing device 100, an input device 102, and an output device 104.

Printing devices often include control panels that provide various information to help users operate the devices. Among other things, a control panel can display images that help a user locate and manage problems that arise during the printing process. For example, when there is a paper jam in a printer, the printer's control panel typically displays an image of the printer that indicates where the jam is located and which door to open up to remove the jam. The image may illustrate the printer from a certain angle and include an animation of a particular door opening and closing in order to better help a user locate the paper jam.

Most printing device control panels can also display an image of an external device that is attached to the printing device. Therefore, if a paper jam occurs in the external device, the control panel might display an image of the external device to assist a user in locating and fixing the jam. FIG. 2 illustrates an example of a control panel 200 displaying an image of a paper input device 202 in a conventional printing system such as that shown in FIG. 1. The image 202 indicates where a paper jam is located and which door a user should open to access the paper jam.

Although displaying an image of the input device on the control panel is helpful in locating and fixing an error such as a paper jam, current methods of displaying these images have disadvantages. This is because conventional printing device control panels generally display devices in isolation from the rest of the system to which the devices are attached. Thus, a displayed device image illustrates only one part of an overall printing system. This type of image display can be problematic for inexperienced users.

For example, it can be difficult for a casual user to discern where a printer ends and where another device begins on a complex printing system that includes external devices such as input paper storage devices and output document finishing devices. Therefore, when a printer's control panel displays only the image of an input device to help a user remedy a paper jam, the user can be confused as to precisely where to look on the system to find the paper jam. The display of an input device by itself lacks context with respect to the overall printing system. The printing system typically includes numerous access doors, each having a similar appearance, that are located at various places on both the printer and its external devices.

Thus, an inexperienced user may have trouble understanding an image of a single device being displayed outside the context of the overall system to which the single device is attached. This can result in difficulties and delays for casual users wanting to correct problems such as paper jams encountered while operating a printing system.

Other disadvantages with current methods of displaying external device images on a printer's control panel relate to maintaining an updated library of images either on the printer or on the external device. Some external devices store images that include the external device and the printer for which the external device was designed. Conversely, some printers store images that include the printer and various external devices that have been designed for use with the printer. Therefore, a printer can display system images that include both the printer and an external device. However, these images do not include any other external devices that may be attached to the printer as part of the overall system. Furthermore, as new external devices are developed for use with a particular printer, it becomes increasingly difficult to update and maintain a library of images on the printer that adequately accounts for the new external devices. Similarly, as new printers are developed that are capable of functioning with existing external devices, external device image libraries are rarely updated to include the newly developed printers. Therefore, external devices often provide images that do not adequately represent a newly developed printer to which the external device may be attached.

Accordingly, the need exists for a way to merge various images from different devices that are part of a printing system so that a control panel can display a comprehensive image that includes all the devices in the system without the need for updating image libraries each time a new printer or a new device is introduced.

### SUMMARY

Images from various devices in a printing system are combined in order to display an overall system image on a control panel of a printing device. Events in a printing system are associated with particular event codes. For example, an error event such as a paper jam in a printing device or other device coupled to the printing device is associated with a particular error code. When an event occurs, a printing device receives an associated event code. Based on the event code, the printing device merges images from one or more external devices with an image of itself. The merged image makes up an overall printing system image that is displayed on a control panel of the printing device. The system image provides information to a user about the nature and location of the event.

In one embodiment, a printing device retrieves external device images upon initialization of the printing system. Appropriate images are then merged as a system image and displayed on a control panel once an event code is received. In another embodiment, a printing device retrieves external device images after receiving an event code and merges the images for display on a control panel. Further embodiments include a printing device that receives an event code from its own sensors which detect an event on the printing device, and a printing device that receives an event code from an external device attached to the printing device.

### BRIEF DESCRIPTION OF THE DRAWINGS

The same reference numbers are used throughout the drawings to reference like components and features.

FIG. 1 illustrates an example of a printing system that includes a printing device, an input device and an output device.

FIG. 2 illustrates a control panel on a printing device displaying an image of an external device as it would appear in the prior art.

FIG. 3 illustrates a system environment that is suitable for merging control panel images.

FIG. 4 illustrates examples of printing devices that might be part of a printing system within a system environment such as that shown in FIG. 3.

FIG. 5 is a block diagram illustrating in greater detail, an exemplary embodiment of a host computer and printing system devices such as those shown in FIG 3.

FIG. 6 illustrates examples of how a typical input device, output device, and printing device might appear in isolation from one another.

FIG. 7 illustrates a view of an input device such as that shown in FIG. 6 from an angle that shows its front and side.

FIG. 8 illustrates a control panel on a printing device displaying a merged printing system image.

FIG. 9 is a flow diagram illustrating an example method of merging control panel images.

FIG. 10 is a flow diagram illustrating an alternate example method of merging control panel images.

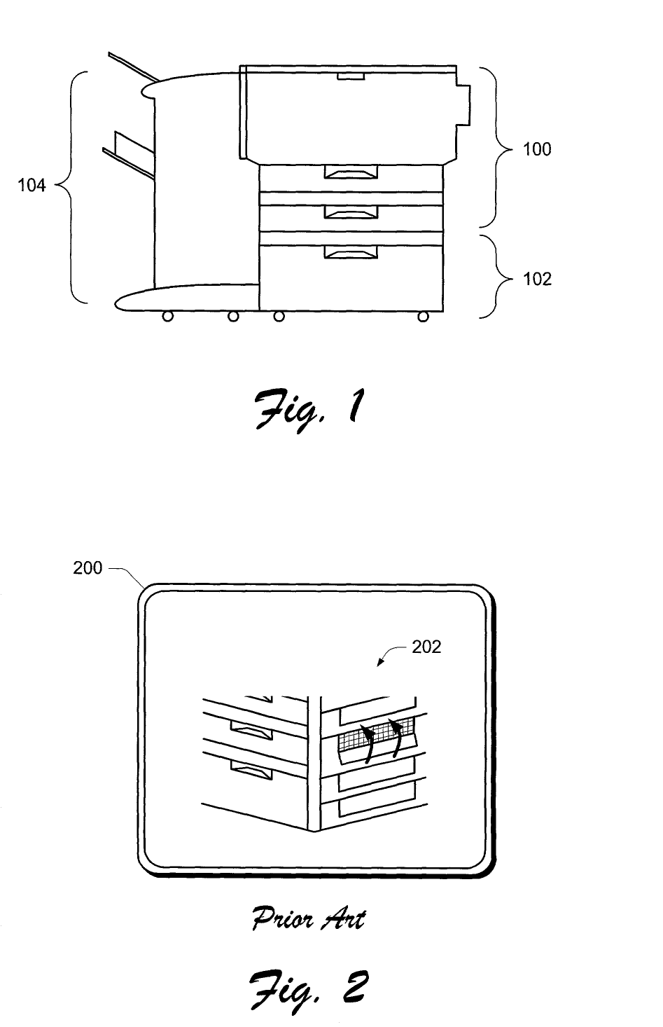

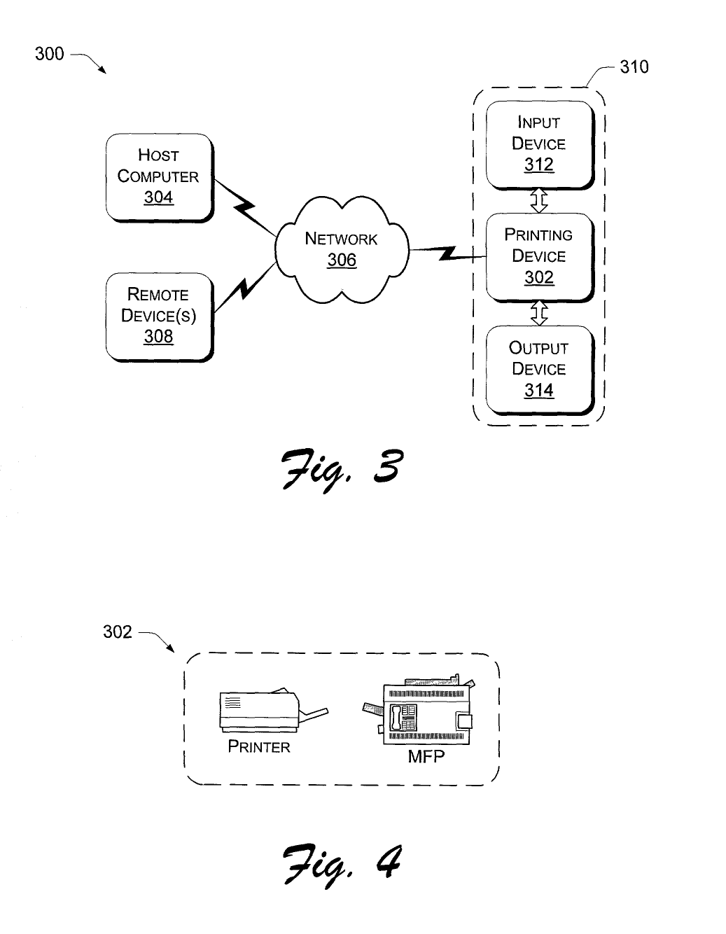

### DETAILED DESCRIPTION

The system and methods described herein relate to merging images on a control panel of a printing device so that an image displayed in the control panel illustrates an entire printing system rather than just one component of that system. Advantages of the disclosed system and methods include more readily recognizable images displayed on control panels and an increase in the flexibility of device development due to a reduced need for updating device image libraries. The images generally provide increased information to a user about operating the printing system and correcting printing system errors.

Exemplary System Environment For Merging Control Panel Images

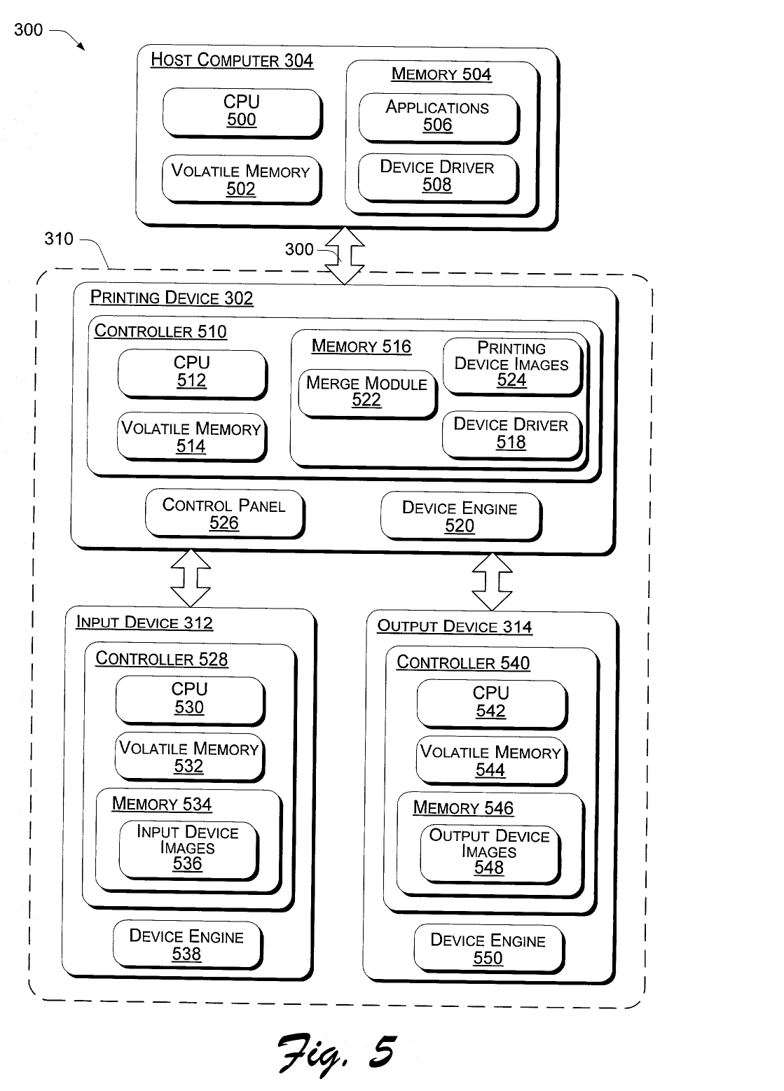

FIG. 3 illustrates a system environment that is suitable for merging control panel images. The system environment 300 of FIG. 3 includes printing device 302 operatively coupled to a host computer 304 through a direct or network connection 306. The system 300 may also include additional remote device(s) 308 coupled to printing device 302 and host computer 304 through network 306. The direct or network connection 306 can include, for example, a printer cable, a LAN (local area networks), a WAN (wide area networks), an intranet, the Internet, or any other suitable communication link.

This disclosure is applicable to various types of printing devices 302 capable of displaying images on a control panel. FIG. 4 illustrates examples of printing device 302. Printing device 302 can include various printing devices such as laser-based printers, ink-based printers, dot matrix printers, dry medium printers, plotters and the like. In addition, printing device 302 can include various multi-function peripheral (MFP) devices that combine a printing function with other functions such as faxing, scanning, copying and the like.

Host computer 304 and remote device(s) 308 can be implemented as a variety of general purpose computing devices including, for example, a personal computer (PC), a server, a Web server, and other devices configured to communicate with printing device 302. Host computer 304 typically provides a user with the ability to manipulate or otherwise prepare in electronic form, an image or document to be rendered as an image that is printed or otherwise formed onto a print medium by printing device 302 after transmission over network 306. In general, host computer 304 outputs host data to printing device 302 in a driver format suitable for the device 302, such as PCL or PostScript. Printing device 302 converts the host data and outputs it onto an appropriate recording media, such as paper or transparencies.

The system environment 300 of FIG. 3 also includes, as part of a printing system 310, one or more external devices operatively coupled to printing device 302. The external devices can include devices such as an input device 312 and an output device 314. Thus, printing system 310 of FIG. 3 typically includes printing device 302 and one or more external devices such as input device 312 and output device 314. Input device 312 is typically an external paper storage device that is attached to printing device 302 to reduce the frequency with which printing device 302 needs to be reloaded with paper or provide paper input capabilities for paper sizes not supported by the internal trays of printing device 302. Output device 314 is typically a document finishing device that provides document finishing functions such as paper sorting, paper stapling, paper stacking and paper binding. Output device 314 might offer various ways of stapling documents together such as placing staples down the side of a document, or placing a staple in the corner of a document at different angles.

Exemplary System Embodiments For Merging Control Panel Images

FIG. 5 illustrates an exemplary embodiment of the system 300 in more detail. Host computer 304 includes a processor 500, a volatile memory 502 (i.e., RAM), and a non-volatile memory 504 (e.g., ROM, hard disk, floppy disk, CD-ROM, etc.). Nonvolatile memory 504 generally provides storage of computer readable instructions, data structures, program modules and other data for host computer 304. Host computer 304 may implement various application programs 506 stored in memory 504 and executed on processor 500 that create a document or image (e.g., text and graphics) on a computer screen that is transferred to printing device 302 for creating a hard copy of the document/image. Such applications 506 might include software programs implementing word processors, illustrators, computer-aided design tools and the like. Host computer 304 may also implement one or more software-based device drivers 508 stored in non-volatile memory 504 and executed on processor 500 to format document data into page description language (PDL) such as PostScript or printer control language (PCL) or another appropriate format which it outputs to printing device 302. A device driver 508 might also be implemented on the specific device it is “driving”, such as discussed below with respect to device driver 518 on printing device 302.

Printing device 302 has a controller 510 that processes data from host computer 304. The controller 510 typically includes a data processing unit or CPU 512, a volatile memory 514 (i.e., RAM), and a nonvolatile memory 516. Nonvolatile memory 516 can include various computer storage media such as ROM, flash memory, a hard disk, a removable floppy disk, a removable optical disk and the like. Nonvolatile memory 516 generally provides storage of computer readable instructions, data structures, program modules and other data for printing device 302. Printing device driver module 518 is executable on processor 512 to format host data into page description language (PDL) such as PostScript or Printer Control Language (PCL) or another appropriate format to control the output of printing device 302 through printer device engine 520. Device driver 518 might also be implemented on host computer 304 as discussed above.

In the exemplary embodiment of FIG. 5, printing device 302 also includes merge module 522 and printing device images 524 stored in memory 516. Merge module 522 executes on processor 512 to combine images from printing device 302 with images from other devices of printing system 310. Merge module 522 operates in various ways to access and combine images as described in greater detail below. After merging images into an overall image of printing system 310, merge module 522 displays the overall system image on control panel 526.

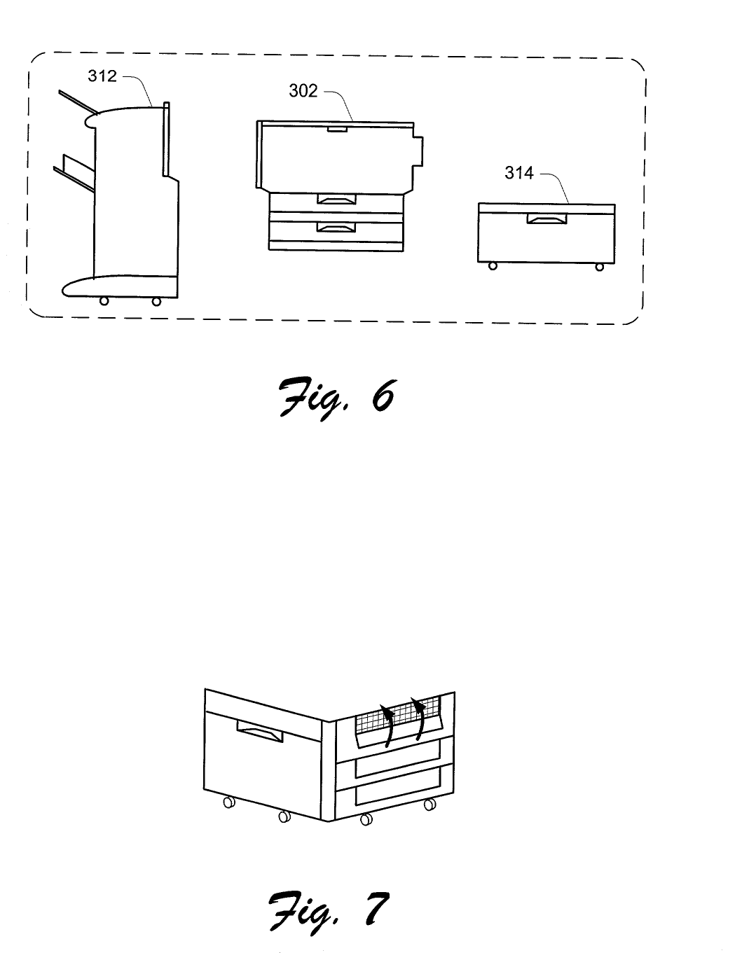

Input device 312 and output device 314 are examples of external devices that might be attached to printing device 302 as part of printing system 310. FIG. 6 illustrates examples of how a typical input device 312, output device 314, and printing device 302 might appear in isolation from one another. Input device 312 typically includes a media storage/input device that provides large quantities of accessible print media to printing device 302 and/or provides paper input capabilities for various paper sizes not supported by the internal trays of printing device 302. Thus, input device 312 supplements the print media supply typically available to printing device 302 through one or more media trays embedded in printing device 302. This reduces the frequency with which printing device 302 needs to be reloaded with print media (e.g., paper) and increases the media alternatives available for printing device 302.

Input device 312 typically includes controller 528 with a processor 530, volatile memory 532 (i.e., RAM), and nonvolatile memory 534. Memory 534 includes input device images 536. In general, controller 528 responds to input device 312 sensors (not shown) and printing device 302 instructions to control the output of input device 312 through input device engine 538. Controller 528 communicates with printing device 302 through a device management language such as PML (printer management-information-base language) or any other language known by those skilled in the art. Generally, PML is a protocol for monitoring and controlling printer devices and their functions. PML is a subset language of SNMP (simple network management protocol) that defines printer device objects with decimal-separated strings that are used in command queries, for example, to obtain object values.

Output device 314 typically includes a document finishing device that receives printed media output from printing device 302 and puts it in a final form. Thus, output device 314 is typically a paper sorter, paper stacker, paper binder, or some combination thereof. Output device 314 might offer various ways of stapling documents together such as placing staples down one side of a document, or placing a staple in the corner of a document at different angles.

Like input device 312, output device 314 includes a controller 540 with a processor 542, volatile memory 544 (i.e., RAM), and nonvolatile memory 546.

Memory 546 includes output device images 548. In general, controller 540 responds to sensors (not shown) and printing device 302 instructions to control the performance of output device 314 through output device engine 550. Controller 540 communicates with printing device 302 through a protocol as described above.

In a first instance of the exemplary embodiment of FIG. 5, upon initialization of printing system 310, merge module 522 is configured to communicate with input device 312 and output device 314 to facilitate the transfer of input device images 536 and output device images 548 to printing device 302. Thus, upon power-up of printing system 310, for example, input device images 536 and output device images 548 are transferred to memory 516 on printing device 302. Merge module 522 is then further configured in this instance to interpret and respond to event messages or event codes received from input device 312, output device 314 and printing device 302.

Generally, event messages or codes are generated by an input device 312, an output device 314, or the printing device 302 when there is a need to convey information to the user about some operational aspect of one or more of these system devices. Therefore, an event code can include an error code related to an error such as a paper jam that has occurred in a device, an information code related to a low paper supply in a paper tray in a device, and the like.

For example, an error message can be generated during a printing process which indicates that a device within the printing system 310 (i.e., the input device 312, output device 314 or printing device 302) has sensed a problem. The error message contains an error code that identifies the precise nature of the problem, such as a paper jam that has occurred at a particular location in the input device 312. Each of the images stored as input device images 536, output device images 548, and printing device images 524 is associated with a particular event code. Thus, an error code defines appropriate device images for display on control panel 526 that will provide a user with information relevant to the error.

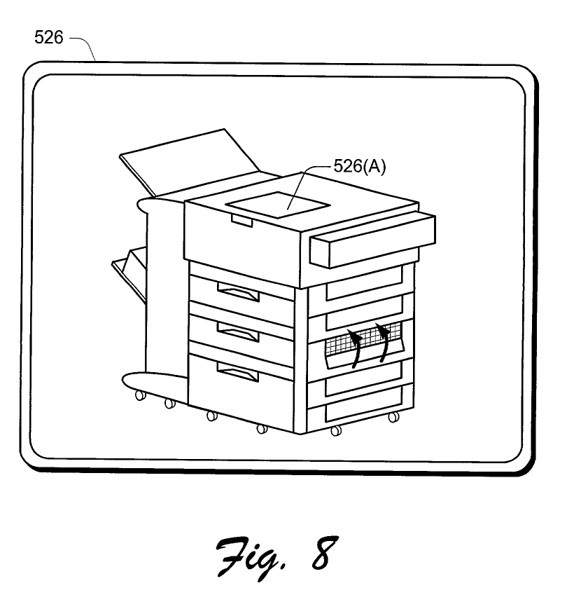

In the first instance of the exemplary embodiment of FIG. 5 mentioned above, upon receiving, for example, an error message from a printing system 310 component (i.e., the input device 312, output device 314 or printing device 302), merge module 522 first responds by issuing an instruction to halt the printing process. Merge module 522 then interprets the error code and retrieves images from its memory 516 that are associated with the error code. The images can include various views of each of the input device 312, the output device 314, and the printing device 302. These device images can include views that are animated or that show the devices from specific angles or distances. FIG. 7 illustrates a view of an input device 312 such as that shown in FIG. 6 from an angle that shows the front and side. In addition, the image of FIG. 7 is animated to show a side panel door opening and closing. Once the merge module 522 retrieves images defined by the error code, it merges them into one coherent image of the printing system 310 and displays this image on control panel 526.

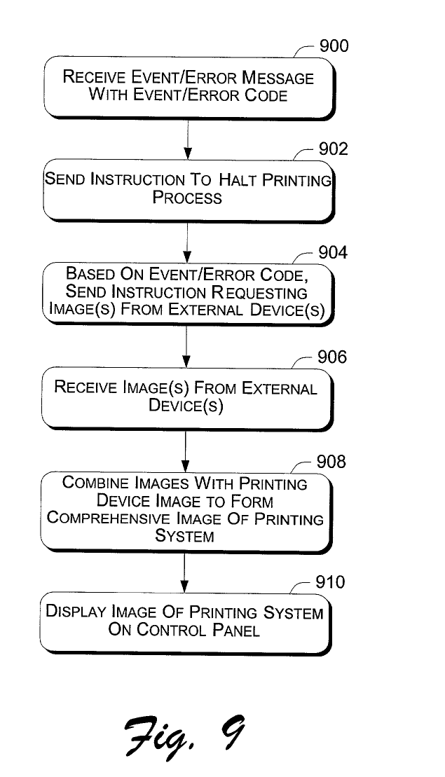

FIG. 8 illustrates an example of a control panel 526 displaying an image of an overall printing system 310. The image combines views of the input device 312, the output device 314, and the printing device 302 that correspond to show a particular angle and distance. In addition, the image displayed in the control panel 526 of FIG. 8 is animated to show a side panel door opening and closing on the input device 312. The displayed image showing the whole printing system 310 clearly indicates to a user where a paper jam has occurred and how to go about fixing the paper jam. Control panel 526(A) on FIG. 8 points out where on printing device 302 a control panel 526 might be located.

In a second instance of the exemplary embodiment of FIG. 5, input device images 536 and output device images 548 are not transferred to printing device 302 upon initialization of printing system 310. Rather, merge module 522 is configured to retrieve the appropriate images from the input device 312, the output device 314, and the printing device 302 upon receiving an event message from one of these devices. Thus, during a printing process, an error message may be received from one of the devices containing an error code that indicates to the merge module 522 the precise nature of an error that has occurred. The merge module 522 then requests the appropriate images as defined by the error code from each of the input device images 536, output device images 548, and printing device images 524 that are stored respectively on the input device 312, the output device 314, and the printing device 302. Upon receiving the requested images, the merge module 522 merges the images into one coherent image of the printing system 310 and displays this image on control panel 526 as discussed above with reference to FIG. 8.

Exemplary Methods For Merging Control Panel Images

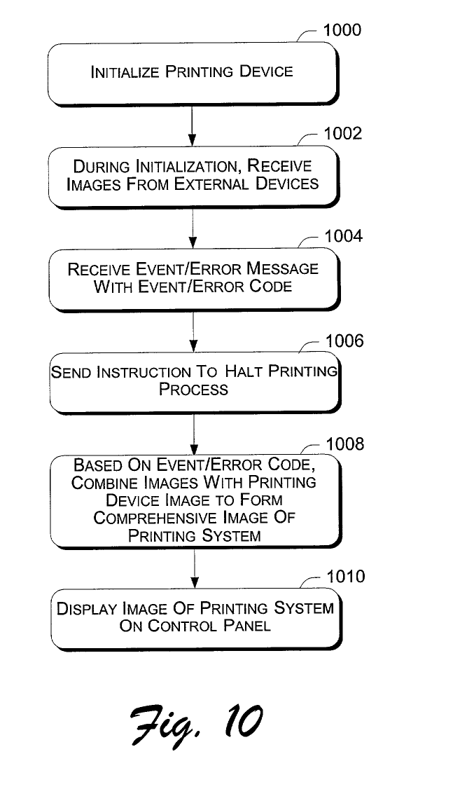

Example methods for merging control panel images will now be described with primary reference to FIGS. 9 and 10. The methods apply generally to the exemplary embodiment of system 300 discussed above with reference to FIG. 5.

FIGS. 9 and 10 are flow diagrams that show examples of general methods for merging images of printing system devices on a control panel display of a printing device. Although FIGS. 9 and 10 and the following discussion pertain to an error event in a printing system 300, this is not intended to limit the applicability of this disclosure to error events. Thus, the general disclosure of methods for merging images of printing system devices on a control panel display is applicable to any type of information event that might occur within a system such as printing system 300.

At block 900 of FIG. 9, a printing device 302 receives an event message such as an error message that includes an error code. The error message has been generated by an external device to printing device 302 or by the printing device 302 itself. The error message generally indicates that an error event has occurred in a printing system 310 device during a printing process that requires information to be conveyed to the user through a control panel 526 in printing device 302.

At block 902, the printing device 302 generates and sends an instruction to halt the printing process. At block 904, the printing device 302 sends an instruction requesting images from each external device based on the error code received in the error message at block 900. At block 906, the printing device 302 receives one or more images from each external device. At block 908, the printing device 302 combines the images with a printing device image to form an overall image of printing system 310. At block 910, the printing device 302 displays the image of the printing system 310 on a control panel of the printing device 302.

FIG. 10 is a flow diagram illustrating an alternate example method of merging control panel images. At block 1000, a printing device 302 is initialized. Initialization typically occurs as a printing system 310 is being powered up. At block 1002, images are received by the printing device 302 from external devices attached to the printing device 302 as part of printing system 310. At block 1004, printing device 302 receives an error message that includes an error code. The error message has been generated by one of the external devices or by the printing device 302. The error message generally indicates that a problem has occurred in a printing system 310 device during a printing process.

At block 1006, the printing device 302 generates and sends an instruction to halt the printing process based on the error message. At block 1008, based on the error code received in the error message at block 1004, the printing device 302 combines some of the received images with a printing device image to form an overall image of printing system 310. At block 1010, the printing device 302 displays the image of the printing system 310 on a control panel of the printing device 302.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A computer-readable medium comprising computer executable instructions configured to cause a computer to perform:
receiving an event code;
based on the event code, receiving an image from each of one or more external devices attached to a printing system;
combining each image with a printing device image to create a system image; and
displaying the system image on a control panel.

2. A computer-readable medium as recited in claim 1, wherein the receiving an event code occurs during a printing process, the computer executable instructions being further configured to cause a computer to perform sending an instruction to halt the printing process.

3. A computer-readable medium as recited in claim 1, wherein the receiving an event code comprises receiving the event code from a printing device.

4. A computer-readable medium as recited in claim 1, wherein the receiving an event code comprises receiving the event code from an external device.

5. A computer-readable medium as recited in claim 1, wherein the receiving an image further comprises sending an instruction to the one or more external devices, the instruction defining the image based on the event code.

6. A computer-readable medium as recited in claim 1, wherein the image and the printing device image are defined by the event code to include characteristics selected from a group of characteristics comprising:
an angle of view;
a distance of view; and
an animated view.

7. A computer-readable medium as recited in claim 1 wherein the control panel is located on the printing device.

8. A computer-readable medium as recited in claim 1, wherein the event code is an error code.

9. A method of merging control panel images comprising:
receiving an event code;
based on the event code, receiving an image from each of one or more external devices attached to a printing system;
combining each image with a printing device image to create a system image; and
displaying the system image on a control panel.

10. A computer-readable medium comprising computer executable instructions configured to cause a computer to perform:
initializing a printing device;
during the initializing, receiving images from one or more external devices;
receiving an event code from an external device;
based on the event code, combining some of the images with a printing device image to form a system image; and
displaying the system image on a control panel.

11. A computer-readable medium as recited in claim 10, wherein the receiving images comprises receiving a group of images from each of the one or more external devices.

12. A computer-readable medium as recited in claim 11, wherein each group of images includes images comprising:
images from various angles;
images from various distances; and
images that are animated.

13. A computer-readable medium as recited in claim 10, wherein the receiving an event code occurs during a printing process, the method further comprising issuing an instruction to halt the printing process.

14. A computer-readable medium as recited in claim 10, wherein the receiving images further comprises requesting the images and identification information from each of the one or more external devices.

15. A computer-readable medium as recited in claim 10, wherein the control panel is located on the printing device.

16. A computer-readable medium as recited in claim 10, wherein the event code is an error code.

17. A method of merging images on a control panel comprising:
initializing a printing device;
during the initializing, receiving images from one or more external devices;
receiving an event code from an external device;
based on the event code, combining some of the images with a printing device image to form a system image; and
displaying the system image on a control panel.

18. A computer-readable medium comprising computer executable instructions configured to cause a computer to merge images on a control panel by performing:
during a printing process, sensing an event on a printing device, the event being associated with an event code;
requesting an image from each of one or more external devices, each image being defined by the event code;
forming a system image from each image and a printing device image, the printing device image being defined by the event code; and
displaying the system image on a control panel.

19. A computer-readable medium as recited in claim 18, wherein the requesting further comprises:
sending an instruction to the one or more external devices, the instruction defining each image based on the event code; and
receiving an image from each of the one or more external devices.

20. A computer-readable medium as recited in claim 18, wherein each image and the printing device image are defined by the event code to include characteristics selected from a group of characteristics comprising:
an angle of view;
a distance of view; and
an animated view.

21. A method of merging images on a control panel comprising:
during a printing process, sensing an event on a printing device, the event being associated with an event code;
requesting an image from each of one or more external devices, each image being defined by the event code;
forming a system image from each image and a printing device image, the printing device image being defined by the event code; and
displaying the system image on a control panel.

22. A printer comprising:
a control panel;
a printer image; and
a merge module configured to combine the printer image with one or more external device images to form a system image, and, to display the system image on the control panel.

23. A printer as recited in claim 22, wherein the printer image and each external device image are determined from an event code.

24. A printer as recited in claim 23, wherein the event code is generated in an external device.

25. A printer as recited in claim 22, wherein the printer image and each external device image illustrate views having particular characteristics selected from a group of characteristics comprising:
an angle of view;
a distance of view; and
an animated view.

26. A printer comprising:
a control panel;
a plurality of printer images; and
a merge module configured to receive external images from each of one or more external devices, form a system image from a printer image and an external image from each of the one or more external devices, and display the system image on the control panel.

27. A system comprising:
a printing device having a control panel and printing device image;
one or more external devices, each external device having an external device image;
wherein the printing device comprises a merge module configured to retrieve the images, combine the images into a system image, and display the system image on a control panel.

28. A system comprising:
a printing device having a control panel and an image of itself;
one or more external devices, each external device having an image of itself;
wherein the printing device comprises a merge module configured to interpret an event code, retrieve images based on the event code, combine the images into a system image, and display the system image on a control panel.
